(19) United States
(12) Patent Application Publication
(10) Pub. No.: US 2008/0226416 A1
(43) Pub. Date: Sep. 18, 2008

(54) Anti-Rotation Device

(76) Inventors: Michael J. Benns, Knoxville, TN (US); Roger Weigle, Manassas, VA (US)

Correspondence Address: NOVAK DRUCE + QUIGG LLP, 1300 EYE STREET NW, SUITE 1000 WEST TOWER, WASHINGTON, DC, 20005, US

(21) Appl. No.: 11/684,962

(22) Filed: Mar. 12, 2007

(51) Int. Cl. F16B 39/00

(52) U.S. Cl. 411/166

(57) ABSTRACT

An anti-rotation device for securing fasteners is disclosed. The device is deployed over a fastener, such as a hex nut. A plurality of panels engage the top and sides of the fastener. A wire is attached to the device, and is secured to an adjacent hard point. The tension in the wire prevents the nut from rotating but requires no modification to the hex nut, and can be removed easily if desired. A plurality of tabs located about the device provide additional gripping strength and further prevent undesired rotation of the fastener. Easy inspection of the device and its connection wire allows a user to determine that the fastener is still secure, especially desirable where the fastener is in limited access areas.

### FIELD OF THE INVENTION

The invention is directed to a device to prevent a fastener from rotating. More particularly, the invention is directed to a device that can be added to a standard fastener to provide anti-rotation capability, and to prevent the fastener from loosening itself due to vibration or other causes.

### BACKGROUND OF THE INVENTION

Shortly after the first fasteners appeared, a new problem was realized—that fasteners have a tendency to become loose, often with very serious consequences. Often re-tightening a loose fastener only temporarily solves the problem. Vibration is a major cause of fasteners becoming loose over time exposed to such vibration. In other cases, thermal expansion and contraction can act upon a fastener and its surrounding material to loosen the fastener.

There have been many attempts to alleviate this problem. One common attempt is the traditional lock washer. The lock washer is inserted between a nut or bolt head and the mating surface. When tightened, the washer bites into each, increasing the friction and attempting to prevent the fastener from becoming loose. There are drawbacks to the traditional lock washer, however. First, the lock washer is a separate item, which is small and is easily lost, especially when an operator is working in difficult to reach surroundings. Second, the washer damages the fastener and the mating surface, creating opportunities for rust and corrosion to take root. Third, the washer has no provision for an external anti-rotation connection.

Another attempt to alleviate this problem is using threadlock compound. This compound is applied to the threads of either the bolt, nut, or both, and when the threads are engages, a chemical reaction occurs along the threads which acts to bind the two together, but still allowing the fastener to be undone, with sufficient force (usually beyond the vibrational forces acting on the fastener) for service, etc. This approach also has its own challenges. If the threads are not factory-treated with threadlock, then the operator must apply the compound, which can be messy (assuming that the operator has a container of threadlock). Also, there is no provision for an external anti-rotation connection.

Yet another attempt to alleviate this problem is the use of a nylon or resin insert built-in to the fastener. These combination fasteners feature a portion of the threads which is nylon or similar resin, which grips the threads when engaged by the fastener. The force required to overcome the nylon gripping portion is usually much higher than the vibrational forces present. This approach also has shortcomings, however. Once threads are cut into this fastener at the first use, it becomes considerably less able to prevent rotation if reused. In many cases, fasteners with nylon inserts are considered single-use and disposable. Therefore, an operator conducting repair or service, for example, must provide replacement nylon-insert fasteners in order to maintain anti-rotational security. Also, there is no provision for an external anti-rotation connection.

Therefore, there exists a need in the art for an improved anti-rotation device, that is reusable, does not damage the fastener, bolt, or surrounding material, and includes a wire for tying off to an adjacent hard point mount.

In U.S. Pat. No. 5,056,974, entitled “Lug Nut Retainer”, a lug nut retainer is disclosed that holds a lug nut in position proximate to a wheel lug hole to accept a stud extended through the wheel lug hole and keeps the lug nut on the stud while allowing the lug nut to rotate to screw onto and off of the stud. A resilient retaining clip is mounted onto the wheel to hold the lug nut in position near the wheel lug hole and to resiliently urge the lug nut towards the wheel lug hole. The retaining clip is fastened to the wheel lug hole by inserting an arm of the clip through two holes provided in the wheel. This arrangement has several drawbacks, among them, that the wheel in this case must be pre-prepared to accept usage of this retainer, which does not easily adapt to other, non-wheel situations.

In U.S. Pat. No. 5,674,034, entitled “Locking Nut Assembly”, a locking nut assembly for use on a shaft such as the bearing hub of four wheel drive vehicle. The shaft is externally threaded and has a longitudinally extending slot, with a nut thread-mounted on the shaft. A first lock part is mounted on the shaft beneath the nut with a tab which extends into the slot to prevent rotation of the first lock part relative to the shaft. A second lock part is mounted over the nut with a noncircular opening in which the nut is received so that the nut cannot rotate relative to the second lock part. This arrangement requires a bolt or hub to have a slot pre-installed, so that the tab engages and prevents rotation. For bolts that do not have a slot preinstalled, usage of this arrangement is not very workable.

In U.S. Pat. No. 4,812,094, entitled “Locking Fastener Assembly For Threaded Joint”, a locking fastener assembly for axle bearings and the like is free spinning during tightening and removal and is positively held against rotation after installation. The assembly is engageable with an axially slotted male threaded member and includes a nut with female threads and a flange end. A retainer washer includes spaced fingers formed around the nut flange for rotatably supporting the washer at the flanged end of the nut. The washer includes a tab received in the slot of the male threaded member permitting the nut to move axially but not to rotate on the male threaded member. This arrangement requires a specialized fastener nut, along with a separate multi-toothed retainer washer, and separate tab which may become lost, along with the specialized washer. Additionally, no provision is made for a tie-down of the fastener to prevent rotation.

The present invention overcomes the problems and disadvantages associated with current designs and strategies, and provides a new means for preventing rotation of a fastener. The present invention easily installs on an existing standard fastener, either a bolt head or nut, without modification to the existing fastener, Once the invention is pressed onto the fastener, a wire attached to the device is then tightly twisted to a nearby attachment point, eliminating rotation. The device can be used and re-used multiple times, on different fasteners. The device also does not cause damage to the fastener or surrounding area. Finally, the device is ideal for use in locations that are difficult to access to verify if a fastener is securely tightened, since using the wire tie-off prevents rotation, and visible inspection of the device will confirm it remains securely tightened.

### SUMMARY OF THE PRESENT INVENTION

In at least one embodiment of the present invention, an anti-rotation device for fasteners is provided that engages the outer faces of a fastener and includes an integrated wire tie-off for preventing rotation once installed.

In another embodiment of the present invention, an anti-rotation device for fasteners is provided wherein the device is hexagonal-shaped and includes an integrated wire tie-off for preventing rotation once installed.

In another embodiment of the present invention, an anti-rotation device for fasteners is provided wherein the device is hexagonal-shaped, with an adjacent perpendicular surface, and includes an integrated wire tie-off for preventing rotation once installed.

In another embodiment of the present invention, an anti-rotation device for fasteners is provided wherein the device is hexagonal-shaped, with a plurality of gripping tabs arranged about at least one surface, and includes an integrated wire tie-off for preventing rotation once installed.

In another embodiment of the present invention, an anti-rotation device for fasteners is provided wherein the device is hexagonal-shaped of varied sizes, with a plurality of gripping tabs arranged about at least one surface, and includes an integrated wire tie-off for preventing rotation once installed.

In another embodiment of the present invention, an anti-rotation device for fasteners is provided wherein the device is multi-sided and includes an integrated wire tie-off for preventing rotation once installed.

In another embodiment of the present invention, an anti-rotation device for fasteners is provided wherein the device is multi-sided, with an adjacent perpendicular surface, and includes an integrated wire tie-off for preventing rotation once installed.

In another embodiment of the present invention, an anti-rotation device for fasteners is provided wherein the device is multi-sided, with a plurality of gripping tabs arranged about at least one surface, and includes an integrated wire tie-off for preventing rotation once installed.

In another embodiment of the present invention, an anti-rotation device for fasteners is provided wherein the device is multi-sided of varied sizes, with a plurality of gripping tabs arranged about at least one surface, and includes an integrated wire tie-off for preventing rotation once installed.

In another embodiment of the present invention, an anti-rotation device for fasteners is provided wherein the device is cylindrical and includes an integrated wire tie-off for preventing rotation once installed.

In another embodiment of the present invention, an anti-rotation device for fasteners is provided wherein the device is cylindrical, with an adjacent perpendicular surface, and includes an integrated wire tie-off for preventing rotation once installed.

In another embodiment of the present invention, an anti-rotation device for fasteners is provided wherein the device is cylindrical, with a plurality of gripping tabs arranged about at least one surface, and includes an integrated wire tie-off for preventing rotation once installed.

In another embodiment of the present invention, an anti-rotation device for fasteners is provided wherein the device is cylindrical of varied sizes, with a plurality of gripping tabs arranged about at least one surface, and includes an integrated wire tie-off for preventing rotation once installed.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

### DESCRIPTION OF THE DRAWINGS

FIG. 1 is an isometric projection of one embodiment of the present invention.

FIG. 2 is an example of a possible usage of the present invention, to secure a trailer ball hitch.

### DETAILED DESCRIPTION OF THE INVENTION

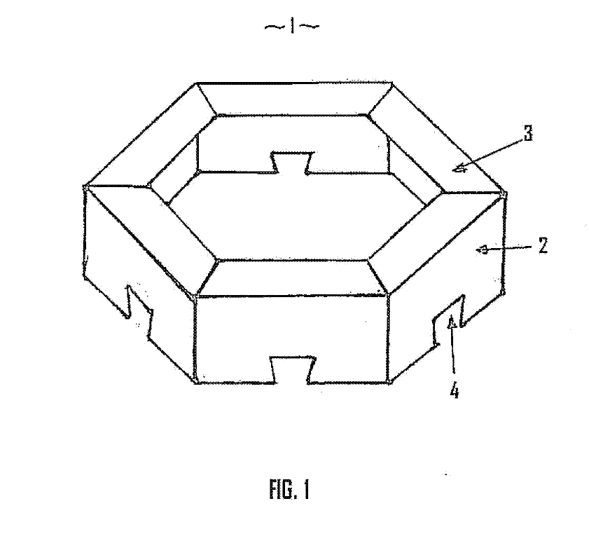

Referring now to FIG. 1, one embodiment of the present is shown. Anti-rotation device 1 is shown with vertical surfaces 2 connected to each other to form, in this embodiment, a hexagon. On the top of vertical surfaces 2 are horizontal surfaces 3, which are securedly connected to vertical surfaces 2 and to each adjacent horizontal surface 3. Gripping tabs 4 are located about the perimeter edge of vertical surfaces 2, opposite of horizontal surfaces 3. The gripping tabs 4 engage the bottom surface of a bolt or nut fastener so as to link the present invention and the fastener as one unit. A securing wire (not shown) is wrapped around the fastener and the present invention and is tied to a nearby secure location, thereby preventing undesired loosening rotation of the fastener.

The device is installed on a bolt or nut by placing it over the fastener, so that the device engages the sides and top surface of the fastener. A wire is also placed to interact with the device and fastener, and so that forcing the device over the fastener and wire results in a tight interference fit. The tabs 4 then grip the bottom of the fastener (the adjacent surface that the fastener is tightened to) to prevent the fastener from slipping in relation to the device. The wire (now partially trapped beneath the device) is secured to a local fixed point, to complete the installation.

For removal, the wire is undone from the local fixed point, and a pair of pliers or similar gripping tools is used to pry the device off of the fastener. The device can be reused or disposed of, depending on the desired application.

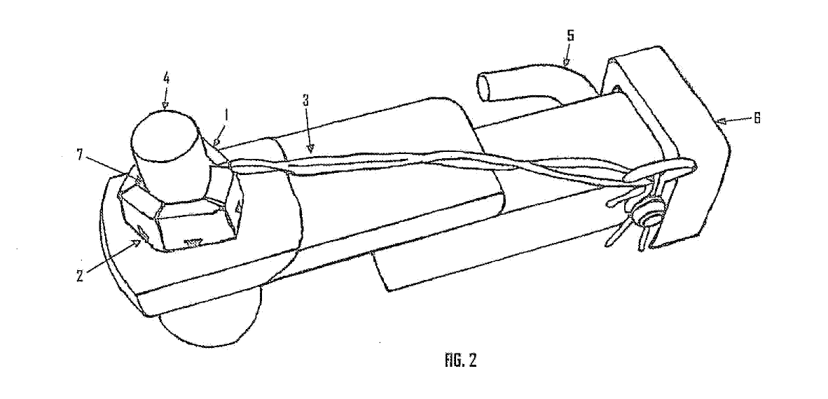

Referring now to FIG. 2, an embodiment of the present invention is shown as used with a vehicle trailer hitch. Anti-rotation device 1 is shown, installed on a nut 7. Device 1 also includes a plurality of tabs 2 and a restraining wire 3. Trailer ball stud 4 is shown engaged with and tightened to nut 7, Wire 3 extends from device 1 to pin 5 on trailer hitch assembly 6.

In this example of one embodiment of the present invention, device 1 is installed on nut 7, which is threaded on to trailer ball stud 4 firmly attached to hitch 6, and the towing vehicle (not shown). In order to install the device 1, an operator first tightens nut 7 to a desired tightness or torque. The operator then places device 1, with wire 3 on top of nut 7 and presses device 1 firmly onto and over the nut 7, so that the tabs 2 (such as shown in this embodiment) engage the surfaces of nut 7. At this point, the device is firmly attached to the nut 7, but in order to completely secure the nut and prevent loosening rotation, wire 3 must be attached to a nearby hard point. In this example, pin 5 of trailer hitch assembly 6 is an ideal location to secure the wire 3. Once the operator twists wire 3 about pin 5 so that the wire 3 is taut, the device has definitively secured nut 7 from rotating loose.

The device 1 allows the operator to easily and quickly visually inspect that the nut 7 is securely tightened by a quick visual inspection of the condition of the wire 3. By viewing wire 3 as taut and secure, the operator can be certain that the nut 3 and trailer ball stud 4 are secured to the trailer hitch assembly 6, without the necessity of locating a proper size wrench and physically checking the nut 7's tightness.

In some embodiments of the invention, tabs 2 are located about the surface of device 1 to increase the gripping strength of device 1 as it engages nut 7. These tabs 2 may be formed by cuffing and bending the material of device 1, as part of the forming of device 1. When an operator pushes device 1 over nut 7, for example, the tabs engage nut 7 about its edges. These engagements further secure device 1 to nut 7, and increase the anti-rotational effect in conjunction with wire 3.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. An anti-rotation device to be inserted over a fastener comprising:
a first plurality of panels disposed radially about an axis;
a second plurality of panels disposed perpendicularly to and formed from said first plurality of panels about said axis;
a plurality of tabs for gripping adjacent surfaces; and
a wire attached to said device.

2. The anti-rotation device of claim 1, wherein said device is constructed of metal.

3. The anti-rotation device of claim 1, wherein said device further comprises a plurality of tabs located about said device for engagement between said device and said fastener.

4. The anti-rotation device of claim 1, wherein said device is constructed of a polymer material.

5. The anti-rotation device of claim 1, wherein said device is chemically treated to resist corrosion.

6. The anti-rotation device of claim 1, wherein said wire is constructed of metal.

7. The anti-rotation device of claim 1, wherein said wire is constructed of resin.

8. An anti-rotation device to be inserted over a socket-head fastener, comprising:
a cylinder;
a plurality of panels attached to one end of said cylinder, and perpendicular to said cylinder;
a plurality of tabs for gripping adjacent surfaces; and
a wire attached to said cylinder.

9. The anti-rotation device of claim 8, said panels further comprising a plurality of bends so as to engage a plurality of sides of said socket-head fastener.

10. The anti-rotation device of claim 8, wherein said device is constructed of metal.

11. The anti-rotation device of claim 8, wherein said device is constructed of a polymer material.

12. The anti-rotation device of claim 8, wherein said device is chemically treated to resist corrosion.

13. The anti-rotation device of claim 8, wherein said wire is constructed of metal.

14. The anti-rotation device of claim 8, wherein said wire is constructed of resin.
